(19) United States
(12) Patent Application Publication
(10) Pub. No.: US 2005/0047445 A1
(43) Pub. Date: Mar. 3, 2005

(54) Clock signal distribution network and method

(76) Inventors: Dmitrii Yu Stepanov, Croydon Park (AU); Ian Mann, Curl Curl (AU); Francois Ladouceur, Glebe (AU); Nobert Krause, Grays Pt (AU)

Correspondence Address: MCDERMOTT, WILL & EMERY, 600 13th Street, N.W., Washington, DC, 20005-3096, US

(21) Appl. No.: 10/681,372

(22) Filed: Oct. 9, 2003

(30) Foreign Application Priority Data
Aug. 29, 2003 (AU) 2003904701

(51) Int. Cl. H04J 3/06

(52) U.S. Cl. 370/503

(57) ABSTRACT

A distribution network for distributing a clock signal comprising a sequence of counter signals, the network comprising a plurality of delivery points for facilitating simultaneous detection of different counter signals to provide timing information, wherein the clock signal comprises a modulated carrier, whereby the sequence of counter signals is in the form of an envelope of the carrier.

### FIELD OF THE INVENTION

The present invention relates broadly to a network and method for clock signal distribution.

### BACKGROUND OF THE INVENTION

Efficient clock distribution is becoming critical to increase the density of clocked components such as transistors on micro-processor chips and, therefore, the micro-processor speed. Traditional electronic distribution of the clock signal is facing limitations such as signal interconnection delays, which in turn limit a faster system throughput, i.e. speed. An electrical interconnection with a large fan-out to reach all of the required clocked components and required to operate at very high frequencies has difficult problems due to limited network band width and driver capability. Controlling a global system clock with small skew bound at high clocking frequencies throughout a large computer system has so far prevented practical implementation of large electronic clock signal synchronous systems.

Introducing optical clock signals to some or all of a clock distribution network is viewed as a potential solution to limitations on clock speed.

Prior art clock distribution methods have identified a need to construct the clock distribution network in what is commonly referred as an H-tree design, in which each of the receiving components have the same clock signal power and source-to-destination path length, which is referred to as a balanced H-tree network configuration. This apparent requirement stems from an approach in such prior art systems of “dividing” the clock signal between several branches from the source to individual terminating nodes, with each terminating node receiving a portion of the “same” clock signal pulse at the same time.

The present invention seeks to provide, in at least preferred embodiments, a novel clock distribution system and method, based on the recognition of at least one novel design criterion.

### SUMMARY OF THE INVENTION

In accordance with a first aspect of the present invention there is provided a distribution network for distributing a clock signal comprising a sequence of counter signals, the network comprising a plurality of delivery points for facilitating simultaneous detection of different counter signals to provide timing information, wherein the clock signal comprises a modulated carrier, whereby the sequence of counter signals is in the form of an envelope of the carrier.

Preferably, path length differences between the delivery points with reference to any point along a common propagation path of the clock signal towards the delivery points are chosen to be equal to or a multiple of a spatial pitch of the sequence of counter signals.

The network may be arranged as a star, ring or mesh network.

In one embodiment the clock signal distribution network comprises a resonant structure.

A clock signal from an external clock source may be coupled into the resonant structure.

The resonant structure may be arranged to generate and maintain the clock signal.

In one embodiment one or more resonant structures are coupled via nodes on the respective resonant structures.

The resonant structure may comprise a ring.

In one embodiment the network comprises a plurality of intersecting sub-networks.

The clock signal may comprise an amplitude modulated carrier, a phase modulated carrier, a frequency modulated carrier, and/or a beat signal of two or more signals having different frequencies.

In one embodiment the clock signal comprises an optical clock signal.

The clock signal may comprise a signal multiplexed into a plurality of channels, whereby the multiplexed clock signal comprises two or more sequences of counter signals in different channels of the multiplexed clock signal.

The sequences of counter signals may have different spatial pitches, and the network comprises different groups of delivery points for facilitating detection of the counter signals from respective sequences, wherein for each group of delivery points at least two different counter signals of one of the sequences are detectable simultaneously at different delivery points of said group.

The sequences of counter signals may have the same spatial pitch with different delays between the sequences in the respective channels, and the network comprises different groups of delivery points wherein optical path length differences between delivery points of different groups with reference to any point along a common path of the clock signal towards the delivery points are chosen to be equal to or a multiple of the delay, whereby counter signals in different channels of the multiplexed signal are simultaneously detectable at the delivery points of different groups.

In one embodiment the clock signal comprises a multiplexed optical signal. The multiplexed optical signal may comprise one or more of a group comprising a WDM signal, a TDM signal and a CDMA signal.

In accordance with a second aspect of the present invention there is provided a distribution network for distributing a clock signal comprising a bidirectional common propagation path for the clock signal; a plurality of delivery points in the common propagation path for facilitating detection of counter signals to provide timing information, two clock signal portions in the common path counter propagating at the same propagation speed, whereby a standing wave clock signal exists in the common path, and wherein each clock signal portion comprises a modulated carrier signal, whereby a sequence of counter signals is simultaneously detectable at the delivery points as changes in an envelope of the standing wave clock signal.

The clock signal may comprise an amplitude modulated carrier, a phase modulated carrier, a frequency modulated carrier, and/or a beat signal of two or more signals having different frequencies.

In one embodiment the clock signal comprises an optical clock signal.

In accordance with a third aspect of the present invention there is provided a method of distributing a clock signal comprising a sequence of counter signals, the method comprising the steps of providing the clock signal in the form of a modulated carrier, whereby the sequence of counter signals is in the form of an envelope of the carrier, and simultaneously detecting different counter signals at a plurality of delivery points to provide timing information.

In accordance with a fourth aspect of the present invention there is provided a method of distributing a clock signal comprising the steps of counter propagating two clock signal portions in a common path at the same propagation speed, whereby a standing wave clock signal exists in the common path, wherein each clock signal portion comprises a modulated carrier, and detecting a sequence of counter signals simultaneously at different delivery points in the common path as changes in an envelope of the standing wave clock signal.

### BRIEF DESCRIPTION OF THE DRAWINGS

Preferred embodiments of the present invention will now be described, by way of example only, with reference to the accompanying drawings.

FIG. 1 is a schematic drawing illustrating an H-tree prior art architecture signal distribution.

FIG. 2 is a schematic drawing illustrating an optical clock distribution network embodying the present invention.

FIGS. 3A) and B) are schematic drawings illustrating other optical clock signal distribution networks embodying the present invention.

FIG. 4 is a schematic drawing illustrating another optical clock signal distribution network embodying the present invention.

FIG. 5 is a schematic drawing illustrating another optical clock signal distribution network embodying the present invention.

FIG. 6 is a schematic drawing illustrating another optical clock signal distribution network embodying the present invention.

FIG. 7 shows a graph illustrating an optical clock signal for use in the present invention.

FIG. 8 is a schematic drawing illustrating another optical clock signal distribution network embodying the present invention.

FIG. 9 is a schematic drawing illustrating another optical clock signal distribution network embodying the present invention.

FIG. 10 is a schematic drawing illustrating another optical clock signal distribution network embodying the present invention.

### DETAILED DESCRIPTION OF THE EMBODIMENTS

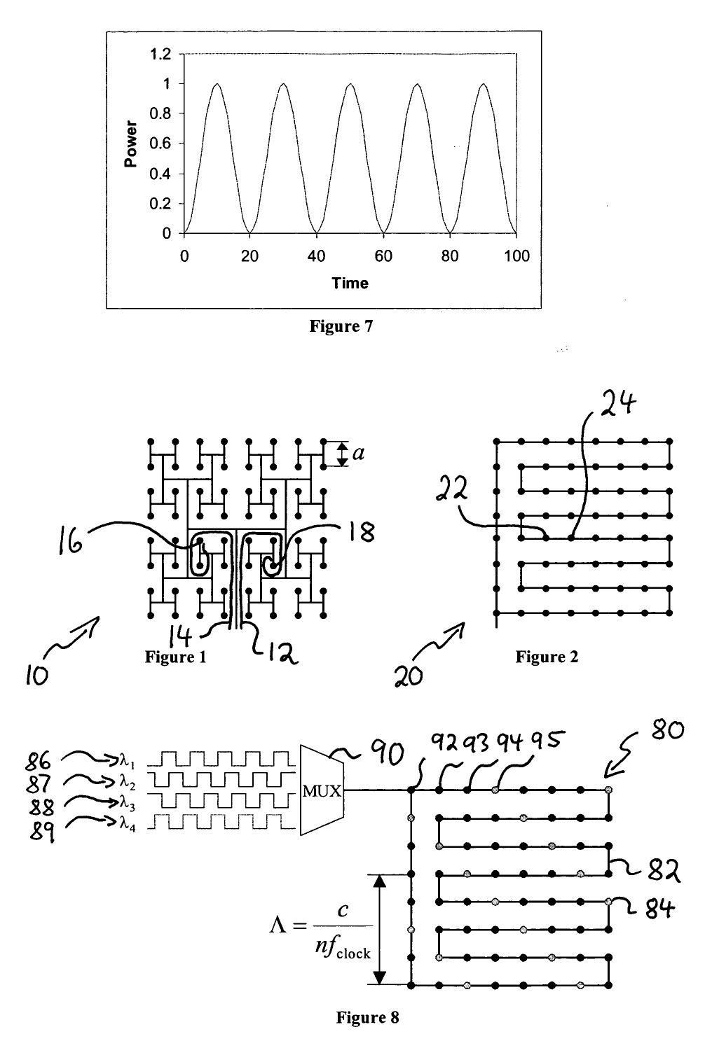

FIG. 1 is a schematic drawing showing a prior art approach to optical clock distribution in a so-called H-tree architecture 10. An optical clock signal comprising a sequence of counter signals is distributed optically along optical paths e.g. 12, 14 having the same optical path length, to termination points 16, 18 as delivery points for timing information.

In contrast, in an embodiment of the present invention shown in FIG. 2, optical clock distribution is realised in an optical clock signal distribution ring network configuration 20. The ring network 20 comprises nodes e.g. 22, 24 as delivery points for timing information. In the example embodiment, it covers the same number of delivery points and at the same locations as in the H-tree architecture 10 (see FIG. 1) for comparison. The distances between the nodes e.g. 22 and 24 are equal to or multiples of a counter signal pitch of the optical clock signal.

In other words, path length differences between different nodes, e.g. 22 and 24 with reference to any point along the common path of the clock signal towards the delivery points are equal to or multiples of the counter signal pitch of the clock signal.

In the present invention, the counter signal is generated through modulation applied to a clock signal carrier, being an optical carrier in the example embodiment shown in FIG. 2. The modulation techniques may include e.g. amplitude modulation, phase modulation, or frequency modulation, or any combination of one or more of different modulation techniques. The modulation may be applied in a coded manner.

In another embodiment the modulated carrier may comprise a beat signal comprising two or more phase-locked CW laser optical signals having different frequencies may be used, the beat signal constituting the sequence of counter signals by virtue of its amplitude rise and fall. Such an embodiment will be described below in more detail with reference to FIG. 7.

It has been recognised by the inventors, that in the ring network 20 embodying the present invention, portions of the same clock signal are delivered to different locations, i.e. the different nodes, e.g. 22, 24 in the sequence of the synchronisation events, with the synchronisation event being sequential counter signals simultaneously arriving at the different nodes.

In contrast, in the prior art H-tree network architecture 10 (see FIG. 1), portions of the same counter signal are delivered to different nodes e.g. 16, 18 at the same moment in time, i.e. as one synchronisation event.

Comparing the architectures in FIGS. 1 and 2, it will be appreciated by a person skilled in the art that the H-tree approach has larger overheads in terms of longer distribution path lengths, number of Y-branches, and 90° bends, which all contribute to the overall loss of the optical clock distribution system. In the example shown in FIG. 1 for 64 nodes, the H-tree network length is 88a, a being a an arbitrary unit distance as indicated in FIG. 1, while the ring network 20 embodying the present invention is only 64.5a long. Furthermore, the inflexible nature of the H-tree network 10 due to the required balancing makes it difficult to adjust to changes in e.g. the chip architecture.

An advantage of the embodiment shown in FIG. 2 is that inaccuracies in the length and coupling ratio at individual nodes do not accumulate with the number of couplers/nodes because coupling-out occurs in parallel rather than in sequence. Each coupling act is independent of the others as in delivering the timing information at the delivery points. This is in contrast to the prior art H-tree architecture shown in FIG. 1,

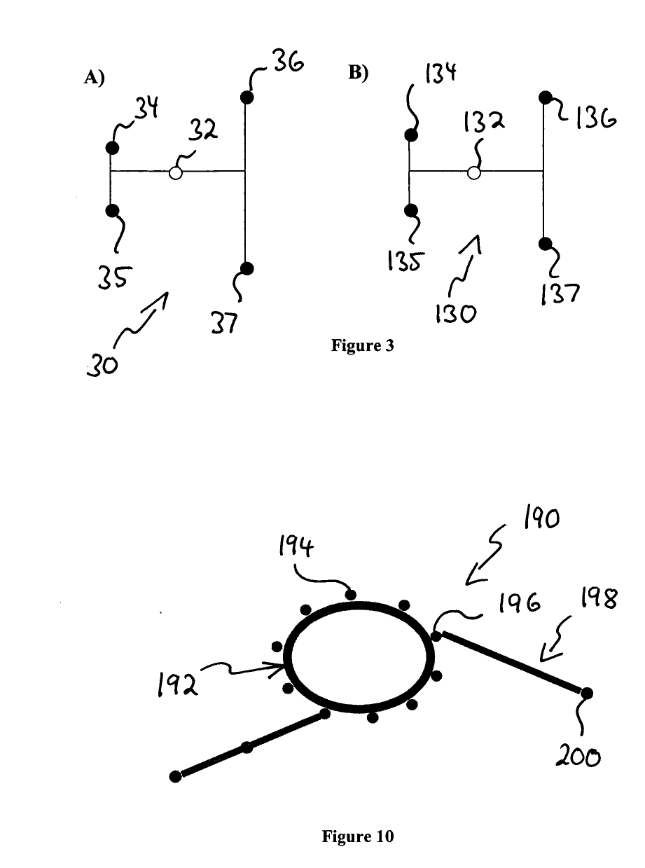

FIGS. 3A) and B) illustrate further embodiments of the present invention, implemented in a star network configuration. Turning initially to FIG. 3A) the optical clock signal distribution network 30 comprises a clock signal source 32, and four nodes 34, 35, 36 and 37 as delivery points for delivering the clock signal to components (not shown). In this embodiment, the optical path lengths for each of the nodes 34 to 37 with respect to the source 32, which represents a point in the common optical path of the clock signal towards the delivery points, are different and the differences are equal to or multiples of the counter signal pitch of the distributed clock signal. Accordingly, different counter signals are detectable simultaneously at the nodes 34 to 37.

In the example embodiment shown in FIG. 3B), the optical clock signal distribution network 130 comprises a clock signal source 132, and nodes 134 to 137 for delivering the clock signal to different components (not shown). In this embodiment, nodes 134 and 135 have the same optical path length from the source 132. Similarly, nodes 136 and 137 have the same path length from the source 132, but their path length is different from the path length for nodes 134 and 135, and the difference is equal to or a multiple of the counter signal pitch.

Accordingly, both nodes of the respective pairs 134, 135 and 136, 137 receive a portion of the same counter signal simultaneously, while each pair receives a different counter signal, but simultaneously.

The example embodiments shown in FIG. 3A) and B) illustrate the increased flexibility of optical clock signal distribution networks embodying the present invention, over the prior art H-tree architecture 10 (see FIG. 1).

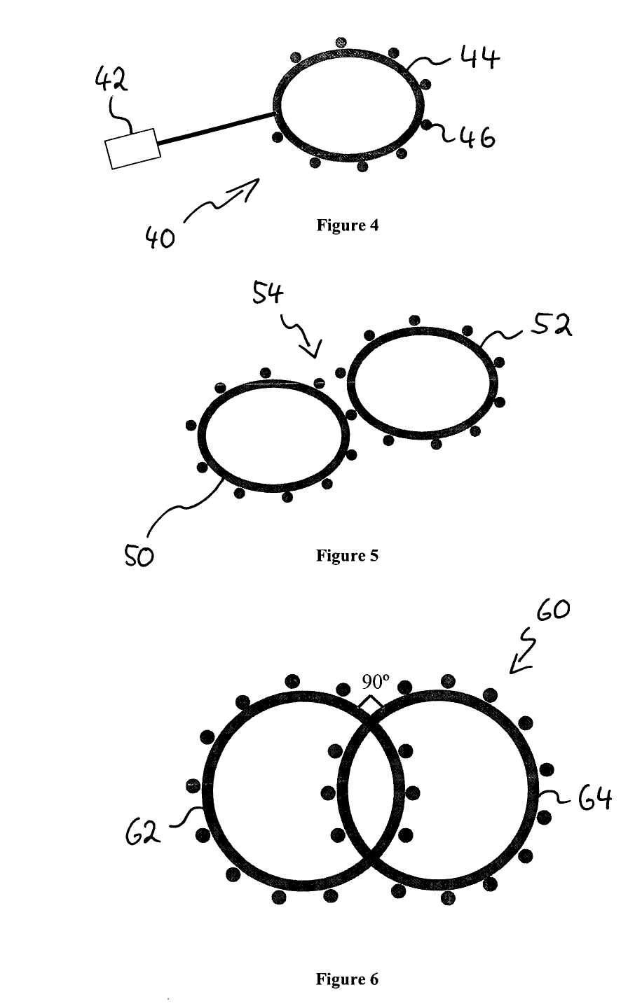

FIG. 4 shows another optical clock signal distribution ring network 40 embodying the present invention. In this embodiment, light from an external laser clock 42 is coupled to a ring cavity 44, which resonates at a sub-harmonic of the clock repetition rate. This allows having a plurality of nodes e.g. 46 to act as deliver points along the ring cavity 44.

In the example embodiment, length distribution of the nodes is chosen to be equal to or multiples of the counter signal pitch, thus enabling that different counter signals at the individual nodes will be detected simultaneously.

In other words, path length differences between different nodes with reference to any point along the common path of the clock signal towards the delivery points are equal to or multiples of the counter signal pitch of the clock signal.

The ring cavity 44 in the example embodiment is approximately 7 mm in diameter and has a resonant frequency of 10 GHz. Thus, if excited at the 10^{th} sub-harmonic, a 100 GHz counter signal train will circulate in the ring cavity 44 with up to 10 output coupling points available, assuming n_{eff}˜1.46 for a silica waveguide implementation of the ring cavity 44 in the example embodiment.

The loss of the signal along the ring cavity 44 from the point of coupling in from the external clock 42 to coupling out at the individual nodes, e.g. 46, is compensated in the example embodiment by amplifying the attenuated optical clock signal. Once the total gain in the ring 44 equals the total loss, the amplifying ring 44 will start to operate as an injection-locked laser, with the master laser being the external clock 42. Passive or active mode synchronisation may be additionally used, with the latter expected to be particularly preferred if the external clock 42 source is absent in an alternative embodiment, and instead sub-harmonic internal active mode-locking is used.

The operation of the ring network can be both unidirectional and bidirectional. If the operation is unidirectional, the front edges of the counter signals are simultaneously registered at the receiving nodes throughout the whole network, with the node spacing period being equal to or a multiple of the counter signal pitch.

If the operation of the network is bidirectional, and the counter signal propagation speed is identical in both directions, a clock signal standing wave can be utilised for synchronization of the nodes, with the tolerances on the nodes spacing period to achieve a desired low value of clock skew being significantly reduced. E.g. if a sinusoidal clock signal is employed in the bidirectional distribution network, the clock signal standing wave represents a sinusoidal standing wave. The standing wave signal is essentially zero in the zero nodes of the standing wave signal. However, it is essentially nonzero anywhere else along the standing wave and thus the clock signal distribution path, with the AC portions of the standing wave signal changing sign simultaneously all over the standing wave and thus the clock signal distribution path (except in the zero nodes). It must be noted that since the clock signal in such an embodiment represents an envelope for the carrier signal, it is the carrier AC portions that change the sign.

One such example embodiment is shown in FIG. 9. The distribution network comprises a bi-directional path 1100. A sinusoidal clock signal is employed bi-directionally to create a standing wave clock signal 1102. The sinusoidal clock signal is a modulated carrier, and the envelope 1104 of the standing wave clock signal 1102 dynamically changes. In this embodiment, sequences of counter signals are simultaneously detectable in detectors 1106, 1108 as a result of the dynamic changes of the envelope 1104.

In another example embodiment shown in FIG. 5, a plurality of rings 50, 52 with the free spectral ranges (FSRs) being proportional are utilised to implement an optical clock signal distribution network. The rings 50, 52 are coupled together to provide the distribution of the clock signal in relevant areas of the clock distribution circuit 54. If the rings 50, 52 operate as lasers as described above with reference to the embodiment shown in FIG. 4, they can be considered as phase-locked oscillators or as one laser with a complex laser cavity. Y-splitters (not shown) can be used locally to distribute the clock signal nearby the local rings 50, 52.

FIG. 6 shows another embodiment of an optical clock signal distribution ring network 60. The network 60 comprises two rings 62, 64, which intersect at right angles with each other. Accordingly, since coupling between waveguides intersecting at right angles is negligible or can be made negligible, the network 60 can be constructed of a number of separate ring sub-networks 62, 64 sharing the same physical space. It may be advantageous to optimise the intersection of the waveguides to minimise the cross-talk. Alternatively, the cross-talk can be maximised if needed, e.g. for locking the sub-networks together, in a modification similar to the embodiment described above with reference to FIG. 5, except that the subnetworks are coupled through the intersections of the waveguides.

Advantages of the example embodiment network 60 include more efficient utilisation of the space in the clock distribution circuit and additional flexibility in the distribution network architecture design.

FIG. 10 shows another embodiment of an optical clock signal distribution network 190. The network 190 comprises a ring portion 192 including a number of nodes e.g. 194 as delivery points. In this embodiment, some of the nodes on the ring portion 192, e.g. node 196, are coupled to non-ring network portions, in the example embodiment single-line distribution portions e.g. 198 to further nodes e.g. 200 as delivery points for delivery of timing information. In this embodiment, again path length differences between the different nodes, e.g. 194 and 200 with reference to any point along the common path of the clock signal towards the delivery points, i.e. any point along the ring portion 192, are equal to or multiples of the counter signal pitch of the clock signal.

The clock distribution network may be implemented using waveguide structures, including photonic or microwave bandgap structures. It will be appreciated by the person skilled in the art that a large variety of materials may be used to implement the waveguide structures, such as polymers, SiO₂/Si, LiNbO₃, Silicon based structures, and other semi-conductor materials.

It can be advantageous to implement the optical clock signal distribution networks embodying the present invention in optical fibre due to very low fibre losses and high flexibility at the manufacturing stage. Tapered fibre is attractive due to its small size and the ability to form bends with small bend radius and still small bend loss. The bend birefringence can be made very low if the bend is annealed, the birefringence reduction being important to reduce the associated polarisation mode dispersion (PMD), which may lead to the skew problems.

Alternatively, the optical clock signal distribution networks embodying the present invention can be implemented as free space waveguide networks, whereby the networks are constructed of bulk components which can be either mounted on a chip or board manually or be e.g. moulded in a single process. The advantage of the free space approach is in its very low loss nature and its extreme architectural flexibility. The skew sensitivity can be somewhat reduced by enclosing the optical path and even creating vacuum in the enclosure.

It will be appreciated by the person skilled in the art, that numerous techniques can be employed to generate the counter signal, including amplitude, frequency, phase or code modulating an optical carrier signal. In an alternative example, the beat of two phase-locked CW lasers may be used as a clock signal. An optical signal can be represented as a superposition of phase-locked frequency components. The more frequency components the signal has, the higher is the duty cycle, i.e. the signal is relatively sharper. An extreme case of only two frequency components shown in FIG. 7 has the minimum duty cycle of 0.5 and can be described by the following waveform
WF=cos(ωt+φ)cos(lΔω)/2+Δφ/2).

Such a waveform can be created by beating the outputs of e.g. two single-frequency semiconductor or fibre lasers, which are locked together. The frequency separation between the lasers should be matched to the free spectral range of the ring resonator and/or to the coupling out devices along a network embodying the present invention, so that the beats appear at e.g. photo detectors at the network nodes simultaneously. The value of the frequency separation between the locked lasers has no limitations, thus, very high clock signal frequencies are available. By increasing the number of locked CW lasers, a variety of clock signal waveforms can be generated. Thus, this technique can have advantages over other techniques to generate the counter signal, such as techniques utilising state of the art modulators. Modulators have cut-off frequencies as a result of limitations of current modulated technologies, limiting the utility of modulator-based techniques for counter signal generation.

Other embodiments of the present invention will now be described, in which an application of multiplexing techniques is utilised, to take advantage of the wide optical bandwidth offered by an optical solution to the clock distribution problem. Multiplexing techniques such as wavelength-division multiplexing (WDM) have been demonstrated extensively in the telecommunications field. It has been recognised by the inventors that the application of such multiplexing techniques is advantageous to the field of optical clock distribution. Other multiplexing methods, e.g. time-division multiplexing (TDM), optical code-division multiplexed access (OCDMA), can also be used, i.e. the present invention is not limited to the WDM approach discussed below with reference to an example embodiment.

One advantage of the multiplexing approach is the possibility to distribute multiple counter signals at e.g. different wavelengths in WDM over the same optical path, saving on real estate and optical power required since shorter optical paths mean less material absorption. The multiple counter signals can be synchronous or asynchronous, operate at different rates and have different modulation formats, e.g. amplitude, phase, frequency or code.

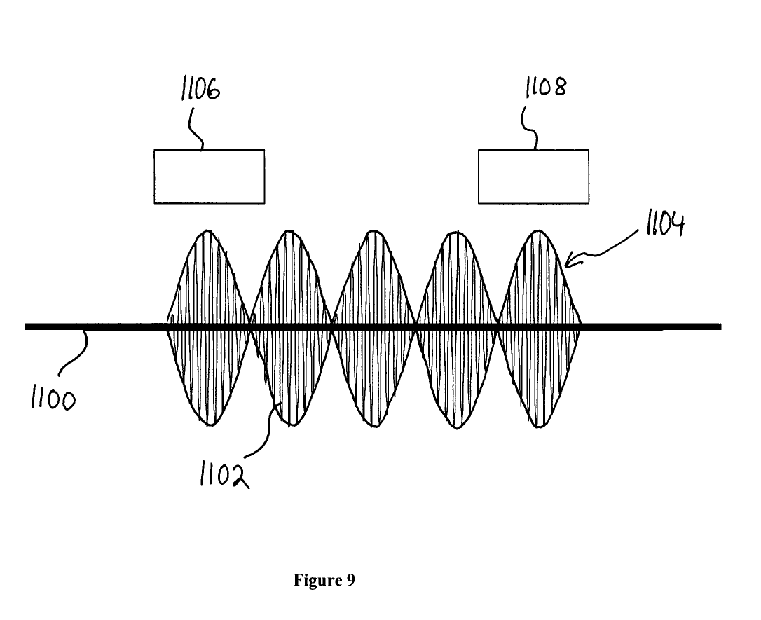

Another advantage of the multiplexing approach is the possibility to distribute a single clock at e.g. different wavelengths in WDM over the same optical path, thus increasing the density of the clock delivery points per area. At high clock rates, the size of the distribution area, e.g. an electronic chip, becomes large compared to the spatial pitch of the counter signals. However, at low clock rates the spatial pitch of the sequential counter signals may be of the order of the size of the distribution area and, to achieve the required density of the clock delivery points, the single optical clock can be multiplexed at the different wavelengths. The counter signals at the different wavelengths are delayed with respect to each other so that the counter signals arrive simultaneously at the individual clock delivery points. This embodiment is schematically shown in FIG. 8.

In FIG. 8, the optical clock signal distribution network 80 embodying the present invention comprises a ring-topology distribution network 82, with a plurality of nodes e.g. 84 as delivery points. In the example embodiment, the optical clock signal comprises four different wavelength counter signals 86-89, which are multiplexed by WDM multiplexing unit 90 before being launched into the network 82.

In the network 82, there are provided four groups of “different” nodes, indicated by different shading in FIG. 8, e.g. nodes 92-95 respectively. Each of the nodes include spectrally selective wavelength “drop” elements (not shown) in order to partially couple the corresponding light carrier out to a photodetector (not shown) so that the counter signal can be received by the photodetector and consumed by dedicated electronic circuits. It will be appreciated by a person skilled in the art, that in the example embodiment, through appropriate selection of the relative delay between the multiplexed clock signals 86-89, and appropriate selection of spacing between nodes of different groups on the one hand, and of spacing between nodes of the same group, the counter signals arrive simultaneously at each of the clock delivery points.

Advantages of using optical multiplexing techniques include:
Reducing real estate required to implement multiple clocks;
Transparency to a variety of modulation formats;
Flexibility to the network architectural changes;
Reducing loss in the optical clock distribution network and as a result reducing power consumption;
Increasing the density of the optical clock delivery points.

Several conventional coupling techniques can be employed to deliver optical signals to detectors or other components of the clock distribution network, e.g. surface relief gratings, mirrors, microlenses, prism coupling and other diffractive optical elements.

In the optical clock signal distribution networks embodying the present invention described above, optical path lengths are important design criteria. As such, under certain circumstances environmentally induced optical path length changes may result in de-synchronisation of the optical outputs at the delivery points and/or shifts in the resonant frequency of a ring cavity utilised in some embodiments. If such conditions are experienced for a particular implementation of the present invention, those undesirable effects may be avoided by utilising active compensation using a feedback loop, or passive compensation utilising compensating packaging structures. In such passive compensation structures, strain induced by the package in the optical medium causes a change in the refractive index of the medium. This change compensates for the environmentally induced refractive index and geometrical length changes. Typically, the critical parameter of the package material is its coefficient of thermal expansion (CTE).

A range of e.g. ceramic materials is available having both positive and negative CTEs, which can be used separately or in combination to yield the required package behaviour. The package may be pre-stressed before forming the light-guiding members onto the package, so that an initial bias to the refractive index is applied and an initial strain has an optimal value.

To address a problem which may be caused due to physical shifts of the output coupling points in the light-guiding circuit, the package may be segmented to provide both compensation of the optical length changes, and for keeping output couplers synchronised to the clock sequence and in the same physical space.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

For example, it will be appreciated that the present invention may be implemented on a single chip, or be applied to optical clock distribution between separate chips in multi-chip module (MCM) configurations. Furthermore, the invention can be applied even at larger length scales. Effects of chromatic dispersion could become measurable at certain clock rates, as those effects grow as square of the clock rates, and suitable counter-measures may be required.

Also, it will be appreciated that while the present invention has been described herein with reference to optical clock signal distribution networks, the present invention is not limited to application in the optical electromagnetic wave range. Rather, it is equally applicable to other electromagnetic wave domains including e.g. the radio frequency (RF), or the microwave domains.

Also, it will be appreciated that the present invention can be implemented as a planar waveguide network, as an optical fibre network, as a free space network, or as a composite network.

In the claims that follow and in the summary of the invention, except where the context requires otherwise due to express language or necessary implication the word “comprising” is used in the sense of “including”, i.e. the features specified may be associated with further features in various embodiments of the invention.

1. A distribution network for distributing a clock signal comprising a sequence of counter signals, the network comprising:
a plurality of delivery points for facilitating simultaneous detection of different counter signals to provide timing information,
wherein the clock signal comprises a modulated carrier, whereby the sequence of counter signals is in the form of an envelope of the carrier.

2. A distribution network as claimed in claim 1, wherein path length differences between the delivery points with reference to any point along a common propagation path of the clock signal towards the delivery points are chosen to be equal to or a multiple of a spatial pitch of the sequence of counter signals.

3. A network as claimed in claim 1, arranged as a star, ring or mesh network.

4. A network as claimed in claim 1, wherein the clock signal distribution network comprises a resonant structure.

5. A network as claimed in claim 4, wherein a clock signal from an external clock source is coupled into the resonant structure.

6. A network as claimed in claim 4, wherein the resonant structure is arranged to generate and maintain the clock signal.

7. A network as claimed in claim 4, wherein one or more resonant structures are coupled via nodes on the respective resonant structures.

8. A network as claimed in claim 4, wherein the resonant structure comprises a ring.

9. A network as claimed in claim 1, wherein the network comprises a plurality of intersecting sub-networks.

10. A network as claimed in claim 1, wherein the clock signal comprises an amplitude modulated carrier, a phase modulated carrier, a frequency modulated carrier, and/or a beat signal of two or more signals having different frequencies.

11. A network as claimed in claim 1, wherein the clock signal comprises an optical clock signal.

12. A network as claimed in claim 1, wherein the clock signal comprises a signal multiplexed into a plurality of channels, whereby the multiplexed clock signal comprises two or more sequences of counter signals in different channels of the multiplexed clock signal.

13. A network as claimed in claim 12, wherein the sequences of counter signals have different spatial pitches, and the network comprises different groups of delivery points for facilitating detection of the counter signals from respective sequences, wherein for each group of delivery points at least two different counter signals of one of the sequences are detectable simultaneously at different delivery points of said group.

14. A network as claimed in claim 12, wherein the sequences of counter signals have the same spatial pitch with different delays between the sequences in the respective channels, and the network comprises different groups of delivery points wherein optical path length differences between delivery points of different groups with reference to any point along a common path of the clock signal towards the delivery points are chosen to be equal to or a multiple of the delay, whereby counter signals in different channels of the multiplexed signal are simultaneously detectable at the delivery points of different groups.

15. A network as claimed in claim 12, wherein the clock signal comprises a multiplexed optical signal.

16. A network as claimed in claim 15, wherein the multiplexed optical signal comprises one or more of a group comprising a WDM signal, a TDM signal and a CDMA signal.

17. A distribution network for distributing a clock signal comprising:
a bi-directional common propagation path for the clock signal;
a plurality of delivery points in the common propagation path for facilitating detection of counter signals to provide timing information,
two clock signal portions in the common path counter propagating at the same propagation speed, whereby a standing wave clock signal exists in the common path, and
wherein each clock signal portion comprises a modulated carrier signal, whereby a sequence of counter signals is simultaneously detectable at the delivery points as changes in an envelope of the standing wave clock signal.

18. A network as claimed in claim 17 wherein the clock signal comprises an amplitude modulated carrier, a phase modulated carrier, a frequency modulated carrier, and/or a beat signal of two or more signals having different frequencies.

19. A network as claimed in claim 17, wherein the clock signal comprises an optical clock signal.

20. A method of distributing a clock signal comprising a sequence of counter signals, the method comprising the steps of:
providing the clock signal in the form of a modulated carrier, whereby the sequence of counter signals is in the form of an envelope of the carrier, and
simultaneously detecting different counter signals at a plurality of delivery points to provide timing information.

21. A method of distributing a clock signal comprising the steps of:
counter propagating two clock signal portions in a common path at the same propagation speed, whereby a standing wave clock signal exists in the common path, wherein each clock signal portion comprises a modulated carrier, and
detecting a sequence of counter signals simultaneously at different delivery points in the common path as changes in an envelope of the standing wave clock signal.
